(19) United States
(12) Patent Application Publication
(10) Pub. No.: US 2007/0269779 A1
(43) Pub. Date: Nov. 22, 2007

(54) Writing Surface in a Spherical Structure

(76) Inventors: Eva Elizabeth Bauer, Menlo Park, CA (US); Hetal Jariwala, Stanford, CA (US)

Correspondence Address: HAYES, SOLOWAY P.C., 175 CANAL STREET, MANCHESTER, NH, 03101, US

(21) Appl. No.: 11/750,557

(22) Filed: May 18, 2007

Related U.S. Application Data
(60) Provisional application No. 60/801,595, filed on May 18, 2006.

(51) Int. Cl. G09B 19/00

(52) U.S. Cl. 434/156

(57) ABSTRACT

This invention provides a device for the workplace, which supports communication while providing entertainment and supporting communication between one or more users. The present invention provides a spherical structure wherein a first hemispherical chamber and a second hemispherical chamber can be separated to reveal an internal writing surface. A user can then record a written message on this writing surface. The first hemispherical chamber and the second hemispherical chamber can then be joined again. Once closed, the spherical structure can be tossed, or alternately reopened to expose the writing surface. This provides one or more users with a way to communicate.

### CROSS REFERENCE TO RELATED APPLICATION

This application claims the benefit of U.S. Provisional Application Ser. No. 60/801,595 filed May 18, 2006, the entire disclosure of which are incorporated herein by reference.

### FIELD OF THE INVENTION

The present invention generally relates to a spherical structure with at least one writing surface embedded therein. The spherical structure may be used as a toy, in the workplace and in a school as a communication tool.

### BACKGROUND OF THE INVENTION

Currently, there are many communication tools that are used as toys, in a workplace and in schools. For instance, video conferencing, telephone conferencing, Powerpoint Presentations, and email are common forms of communication that is used. For simple communications, instant messaging or “sticky notes” are often used.

In many forms of communication it is desirable to provide a fun element to the communication method. Thus toys can be used in the workplace. Ball structures for instance, are used in the workplace to provide a physical outlet for the release of tension. Email messages and Powerpoint Presentations may be adorned with decorative indicia for capturing the attention of the audience. In other instances 3D images are used to creatively communicate a message.

While these devices fulfill their respective, particular objectives and requirements, it is a long felt need in a workplace and teaching environment to provide a communication device that can also be used in a creative or playful manner amongst one or more users.

Thus, a heretofore unaddressed need exists in the industry to address the aforementioned deficiencies and inadequacies.

### SUMMARY OF THE INVENTION

Embodiments of the present invention provide a device and method for sending a message. Briefly described, in architecture, one embodiment of the device, among others, can be implemented as follows. The device includes a first hemispherical chamber. A second hemispherical chamber engages with the first hemispherical chamber. A first writing surface is embedded within the first hemispherical chamber.

The present invention can also be viewed as providing methods for sending a message. In this regard, one embodiment of such a method, among others, can be broadly summarized by the following steps: providing a spherical structure having a first writing surface embedded therein; passing the spherical structure to one or more users; opening the spherical structure; reading the message on the writing surface in the spherical structure.

Other devices, methods, features, and advantages of the present invention will be or become apparent to one with skill in the art upon examination of the following drawings and detailed description. It is intended that all such additional device, methods, features, and advantages be included within this description, be within the scope of the present invention, and be protected by the accompanying claims.

### DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a cross sectional view of a first hemispherical chamber and a second hemispherical chamber in accordance with the first exemplary embodiment of the present invention.

FIG. 2 is a top view of a first hemispherical chamber and a second hemispherical chamber, in accordance with the first exemplary embodiment of the present invention.

FIG. 3 is a top view of a spherical structure in an open position, in accordance with a second exemplary embodiment of the present invention.

FIG. 4 is a side view of the spherical structure of FIG. 3 in a closed position, in accordance with the second exemplary embodiment of the present invention.

FIG. 5 is a top view of a first hemispherical chamber and a second hemispherical chamber, in accordance with a third exemplary embodiment of the present invention.

FIG. 6 is a cross sectional view of a spherical structure, in accordance with a fourth exemplary embodiment of the present invention.

FIG. 7 is a top view of a first hemispherical chamber and a second hemispherical chamber, in accordance with a fifth embodiment of the present invention.

FIG. 8 is a top view of a first hemispherical chamber and a second hemispherical chamber, in accordance with a sixth exemplary embodiment of the present invention.

FIG. 9 is a flowchart illustrating a method of using the spherical structure shown in FIG. 1, in accordance with the first exemplary embodiment of the present invention.

### DETAILED DESCRIPTION OF THE INVENTION

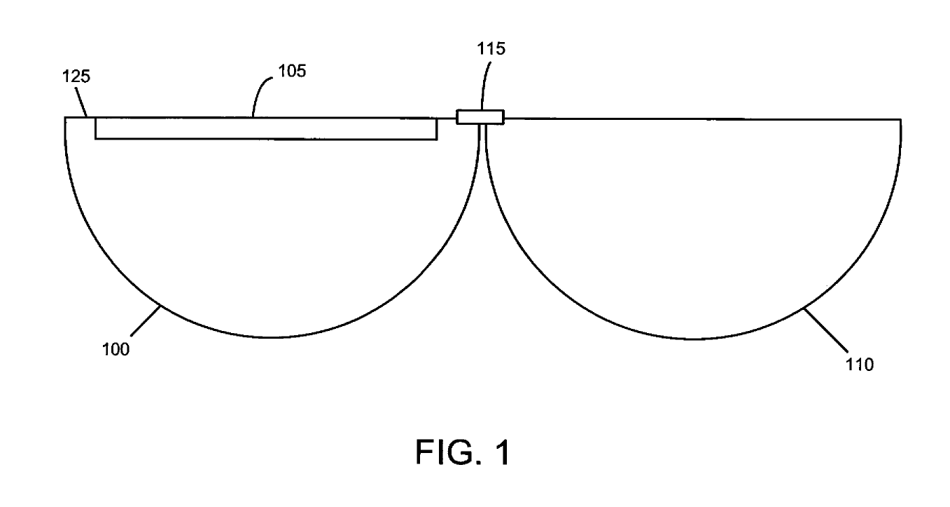

FIG. 1 is a cross sectional view of a first hemispherical chamber and a second hemispherical chamber in accordance with the first exemplary embodiment of the present invention. The spherical structure includes a first hemispherical chamber 100. A second hemispherical chamber 110 is engageable with the first hemispherical chamber 100 A first writing surface 105 is embedded within a ridge 125 in the first hemispherical chamber 100. The first writing surface 105 may be used to write a message to one or more users. The writing surface 105 may be a white board in accordance with the first exemplary embodiment of the present invention.

The first hemispherical chamber 100 may also have a mechanical fastener 115 in accordance with the first exemplary embodiment. The mechanical fastener 115 is used in the first exemplary embodiment to engage the first hemispherical chamber 100 with the second hemispherical chamber 110. Mechanical fastener 115 may be any type of mechanical fastener 115 known to those skilled in the art, including but not limited to captive fasteners, hook and loop fasteners, quick connect fasteners, retaining rings, snap rings, snap fasteners, threaded assemblies, zippers, catches, compression latches, draw latches, spring latches, and hinges. The first hemispherical chamber 100 and the second hemispherical chamber 110 may remain in contact when disengaged or may be entirely separable, depending on the choice of mechanical fastener(s).

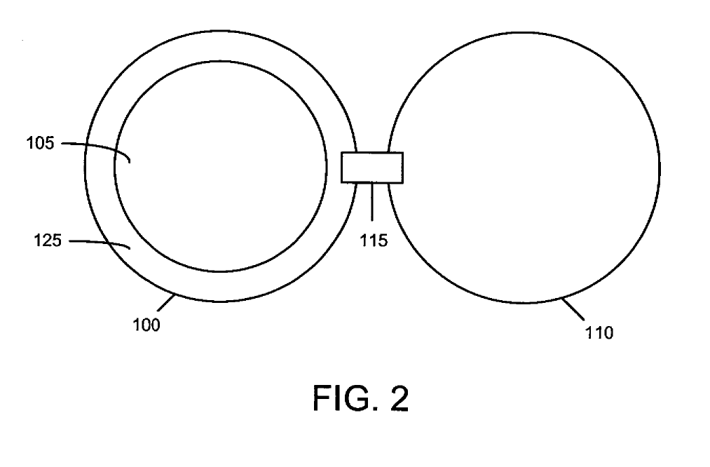

FIG. 2 is a top view of a first hemispherical chamber and a second hemispherical chamber. In this embodiment the first hemispherical chamber 100 is shown with a ridge 125 embedding the first writing surface 105 in the first hemispherical chamber 100. The first hemispherical chamber 100 is engaged to the second hemispherical chamber 110 with the mechanical fastener 1 15. The first writing surface 105 may be any size or shape that will fit into the first hemispherical chamber 100. For instance the first writing surface 105 may be, from the top view, in the shape of a circle, a rectangle, a square or a triangle. In addition the first writing surface 105 may be embedded within a large portion of the top surface of the first hemispherical chamber 100 or may be only partially embedded within the top surface of the first hemispherical chamber 100.

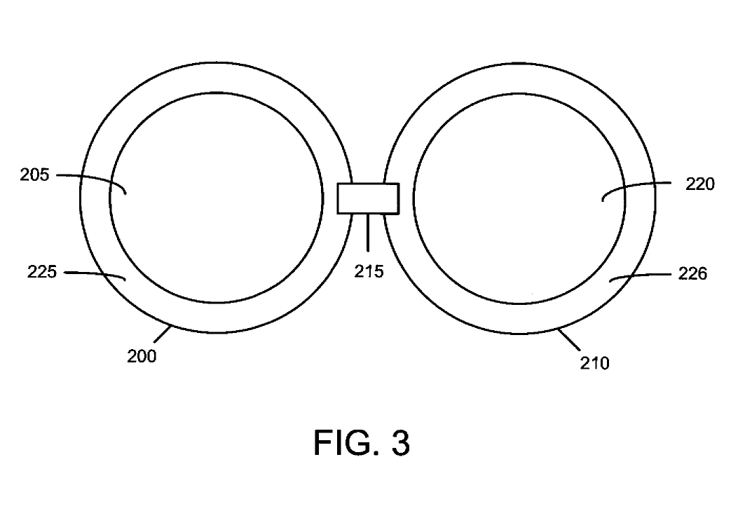

FIG. 3 is a top view of a spherical structure in an open position, in accordance with a second exemplary embodiment of the present invention. In this figure, a first hemispherical chamber 200 and a second hemispherical chamber 210 are shown. A first writing surface 205 is embedded in the first hemispherical chamber 200 and a second writing surface 220 is embedded in the second hemispherical surface 210. A first ridge 225 and a second ridge 226 secure the first writing surface 205 and the second writing surface 220, respectively, in their embedded positions. A mechanical fastener 215 is provided to engage the first hemispherical structure 200 to the second hemispherical structure 210.

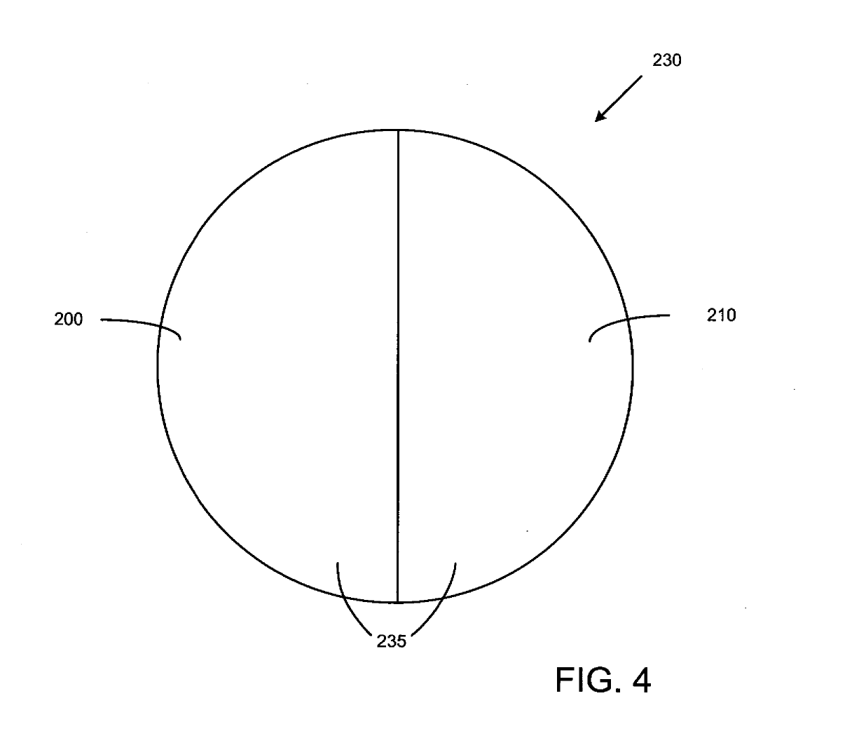

FIG. 4 is a side view of the spherical structure 230 of FIG. 3 in a closed position, in accordance with the second exemplary embodiment of the present invention. The first hemispherical chamber 200 and the second hemispherical chamber 210 are engaged in a closed position to form the spherical structure 230. The spherical structure 230 may be used as a communication tool in the work place, as a teaching instrument, as a toy as well as other uses that would be obvious to one having ordinary skill in the art. For instance a user may write a message on the first writing surface 205 in the first hemispherical chamber 200. In accordance with this embodiment, the user may bounce the spherical structure 230 or throw the spherical structure 230 to one or more users for conveying a message.

FIG. 4 also shows an outer shell 235 of the first hemispherical chamber 200 and the second hemispherical chamber 210. The outer shell 235 may be made of any material that is safe for a user to handle. For instance, the outer shell 235 may be made of an elastomer, rubber, plastic or any soft fabric that may be handled by a user. For instance thermoplastic elastomers, polymers, open cell foam, closed cell foam and granular materials may be used to form the outer shell 235 of the present invention. The outer shell 235 may also be made of any number of plastic materials, including but not limited to low, medium and high density polyethylene, ethylene vinyl acetate, ethylene acrylic acid, ethylene methyl acrylic acid, ethylene vinyl alcohol, surlyn, nylon, polypropylene, polystryrene, polyurethane, polyester and combinations thereof.

The outer shell 235 may also have any number of desired designs and labels may be embedded therein. For instance one or more message indicia may be included in order to satisfy marketing and labeling needs and requirements. When desired one or more or any such design or label can be itself substantially transparent, and the message indicia opaque or translucent or contrasting in order to be visible to the user.

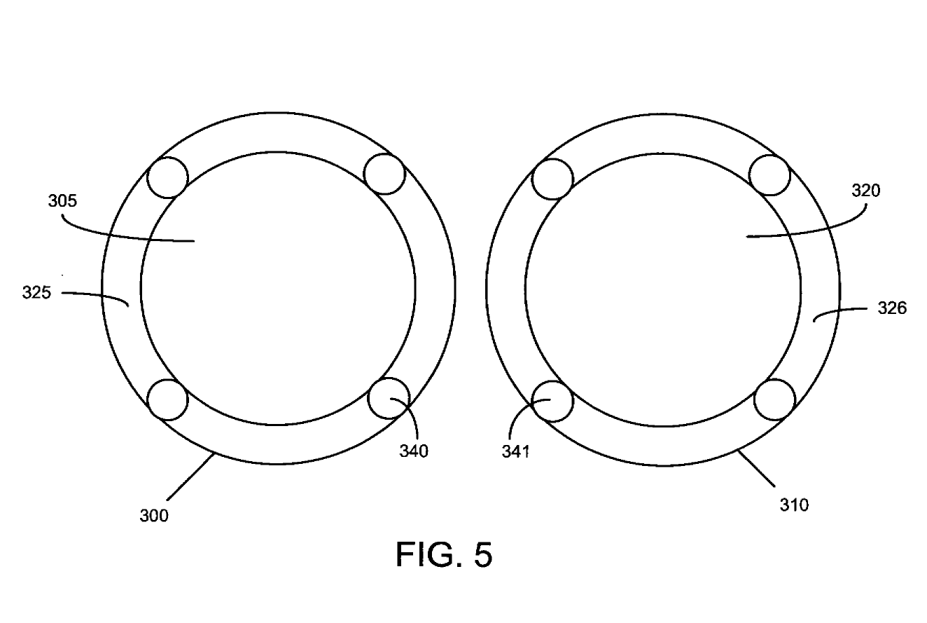

FIG. 5 is a top view of a first hemispherical chamber and a second hemispherical chamber, in accordance with a third exemplary embodiment of the present invention. The first hemispherical chamber 300 is shown in the third exemplary embodiment with a ridge 325 securing a first writing surface 305 embedded in the first hemispherical chamber 300 and a ridge 326 securing a second writing surface 320 embedded in a second hemispherical chamber 310. In addition, a plurality of first patches 340 are integral with the first hemispherical chamber 300 and a plurality of second patches 341 are integral with second hemispherical chamber 310. The plurality of first patches 340 and the plurality of second patches 341 are engageable for closing the first hemispherical chamber 300 on the second hemispherical chamber 310. A plurality of first patches 340 and a plurality of second patches 341, for instance, may be hook and loop fabric fasteners, such as Velcro fasteners, or a reusable adhesive material. The patches 340, 341 may also be embodied by at least one magnet on one hemispherical chamber and at least one magnet and/or a piece of metal or ferromagnetic material that may be engaged by a magnet. Also, while the patches 340, 341 are shown on a periphery of the hemispherical chambers 300, 310, the patches 340, 341 may be within a middle portion of a surface of the hemispherical chambers 300, 310 and/or beneath a surface of the hemispherical chambers 300, 310.

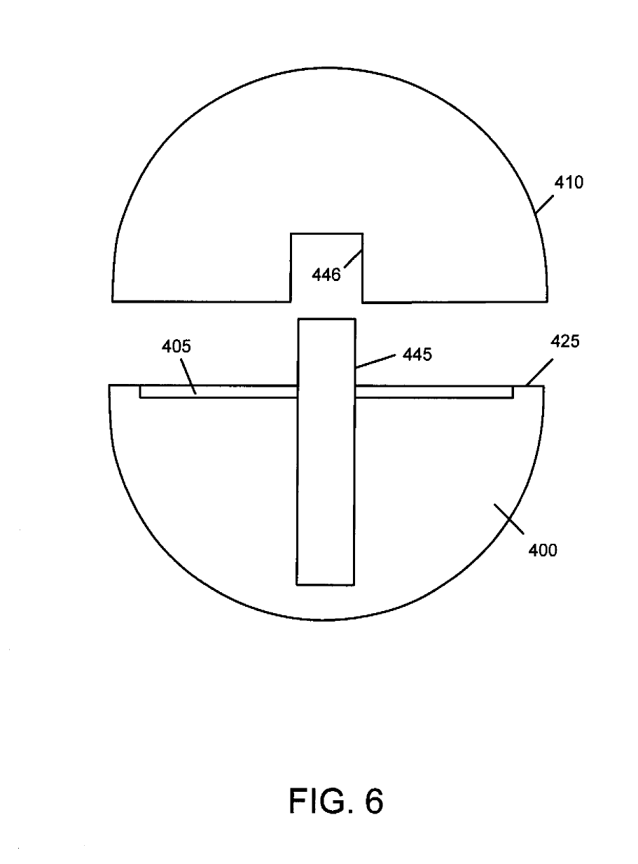

FIG. 6 is a cross sectional view of a spherical structure, in accordance with a fourth exemplary embodiment of the present invention. The first hemispherical chamber 400 includes a first writing surface 405 and a stem 445. In this embodiment, the stem 445 extends through the first writing surface 405, which is embedded in the first hemispherical chamber 400 and secured with a ridge 425. A receiving portion 446 may be provided in a second hemispherical chamber 410. The stem 445 may be engageable with the receiving portion 446 and, thus, used to engage the first hemispherical chamber 400 with the second hemispherical chamber 410.

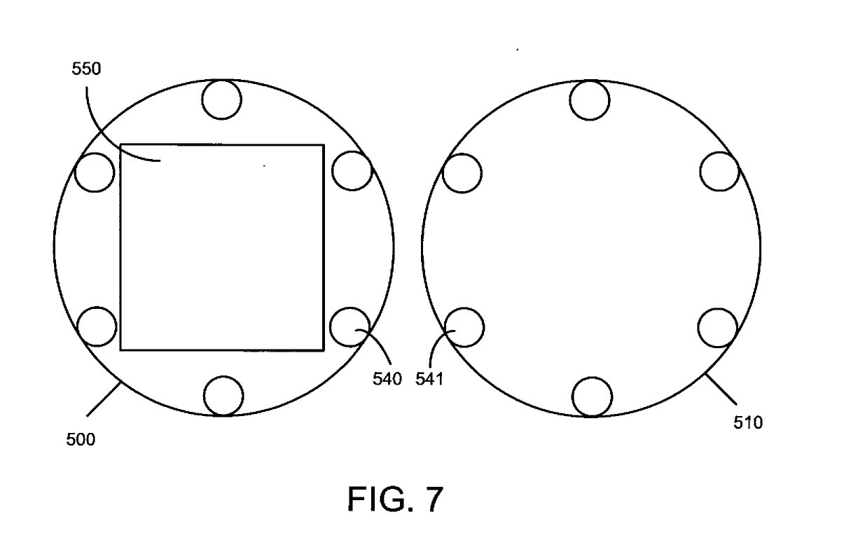

FIG. 7 is a top view of a first hemispherical chamber and a second hemispherical chamber, in accordance with a fifth embodiment of the present invention. The first hemispherical chamber 500 includes a plurality of patches 540 for engaging with a plurality of patches 541 on a second hemispherical chamber 510. A notepad 550 is placed in the first hemispherical chamber 500, such that a user may pass notes in the first hemispherical chamber 500. The notepad 550 may be adhesively attached or placed in an embedded notepad holder in the first hemispherical chamber 500.

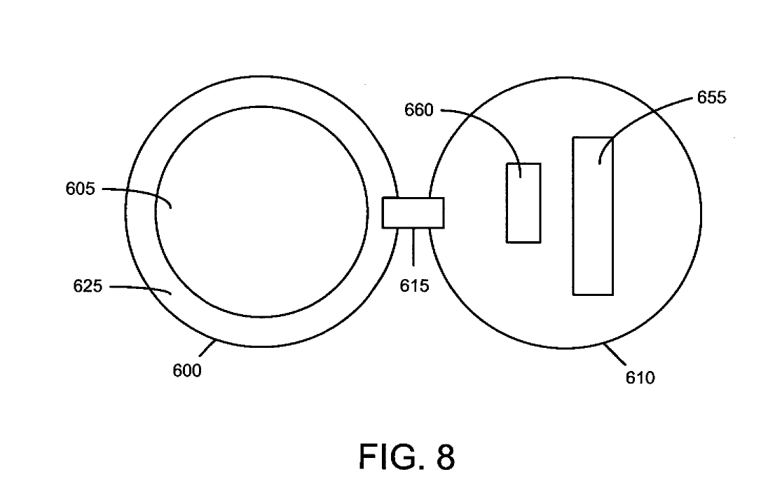

FIG. 8 is a top view of a first hemispherical chamber 600 and a second hemispherical chamber 610, in accordance with the sixth exemplary embodiment of the present invention. In accordance with the sixth exemplary embodiment, the first hemispherical chamber 600 includes a first writing surface 605 embedded therein. The second hemispherical chamber 610 is shown engaged to the first hemispherical chamber 600 through a mechanical fastener 615. In this embodiment, the second hemispherical chamber 610 has a writing utensil port 655 and an eraser port 660 for attaching a writing utensil and an eraser for ease of writing and erasing on the first writing surface 605 by one or more users.

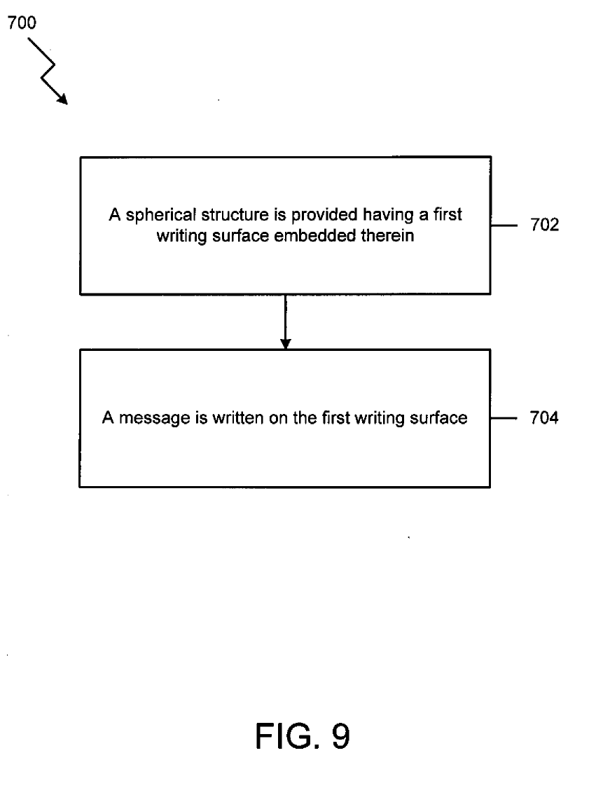

FIG. 9 is a flowchart 700 illustrating a method of using the spherical structure of FIG. 1, in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 702, a spherical structure is provided having a first writing surface embedded therein. A message is written on the first writing surface (block 704). According to the method described, a user may write notes in a spherical structure for personal use. For instance, a user may write phone numbers, reminder notes or short messages on a writing surface or notepad in a spherical structure in accordance with the method described herein. In these embodiments, a single user may use a spherical structure for taking notes at a desk.

Additionally, according the method described, a first message may be conveyed to one or more users by throwing, passing, rolling or bouncing a spherical structure with a first message therein. In one embodiment a second message may be written in a spherical structure and conveyed to one or more users. One or more opening and closing mechanisms are provided for ease of writing and retrieval of a message in a spherical structure.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A device comprising:
a first hemispherical chamber;
a second hemispherical chamber engageable with the first hemispherical chamber; and,
a first writing surface embedded within said first hemispherical chamber.

2. The device of claim 1 further comprising a second writing surface embedded within the second hemispherical chamber.

3. The device of claim 1 further comprising a mechanical fastener for engaging the first hemispherical chamber with the second hemispherical chamber.

4. The device of claim 1 wherein the first hemispherical chamber further comprises a stem.

5. The device of claim 1 further comprising a plurality of first patches integral with the first hemispheric chamber and a plurality of second patches integral with the second hemispheric chamber, wherein the plurality of first patches are engageable with the plurality of second patches.

6. The device of claim 1 further comprising a ridge formed in the first hemispherical chamber, wherein the first writing surface is held by the ridge.

7. The device of claim 1 wherein the first hemispherical chamber and the second hemispherical chamber form a spherical structure.

8. The device of claim 1 further comprising at least one magnet integral with the first hemispheric chamber and a metal object integral with the second hemispheric chamber, wherein the magnet is magnetically engageable with the metal object.

9. The device of claim 1 wherein the first spherical structure and the second spherical structure further comprises an elastic outer shell.

10. A method for writing a message comprising: providing a spherical structure having a first writing surface embedded therein; and,
writing a first message on the first writing surface.

11. The method in accordance with claim 10 further comprising the step of conveying the spherical structure with the first message to at least one user.

12. The method in accordance with claim 10 wherein the writing surface is a white board.

13. The method in accordance with claim 10 further comprising the step of providing a spherical structure with a second writing surface embedded therein.

14. The method in accordance with claim 10 further comprising the step of writing a second message on the writing surface.

15. The method in accordance with claim 14 further comprising the step of conveying the second message to at least one user.

16. The method in accordance with claim 10 further comprising the step of bouncing the spherical structure to at least one user.

17. The method in accordance with claim 10 further comprising the step of providing a writing instrument within the spherical structure.

18. The method in accordance with claim 10 further comprising the step of opening and closing the spherical structure with a mechanical fastener.

19. The method in accordance with claim 10 further comprising the step of providing a plurality of first patches integral with the first hemispheric chamber and a plurality of second patches integral with the second hemispheric chamber, wherein the plurality of first patches are engageable with the plurality of second patches.

20. The method in accordance with claim 10 further comprising the step of closing the spherical structure with an embedded stem.
